(19) United States
(12) Patent Application Publication
(10) Pub. No.: US 2012/0253967 A1
(43) Pub. Date: Oct. 4, 2012

(54) DIGITALLY BASED SYSTEM FOR LEASE PROPERTY SELECTION AND LEASE NEGOTIATION

(76) Inventors: Paul J. McDevitt, Marvin, NC (US); Thomas W. Real, Leeds, AL (US)

(21) Appl. No.: 13/437,868

(22) Filed: Apr. 2, 2012

Related U.S. Application Data
(60) Provisional application No. 61/516,310, filed on Mar. 31, 2011.

(51) Int. Cl. G06Q 30/00

(52) U.S. Cl. 705/26.4

(57) ABSTRACT

A system and method are provided to maximize the number of participants submitting proposals for requirements of all sizes and to increase transparency in property selection to aggregate more data regarding potential lease properties earlier than current practice, qualify candidate properties for lease, expedite and standardize a request for proposal (RFP) process to use the increased transparency to include not just rent, but other costs and lease provisions respecting candidate lease properties, and negotiate a lease for a target candidate property. Additionally, the system and method preferably enable a simultaneous reverse auction process with various potential Lessors on either or both the financial or qualitative lease terms and conditions increasing the outcomes for the Client Operator/Lessee.

### CROSS-REFERENCE TO RELATED PATENT APPLICATION

This application relates to U.S. Application No. 61/516,310 filed on Mar. 31, 2011, entitled DIGITALLY BASED SYSTEM FOR LEASED PROPERTY SELECTION AND LEASE NEGOTIATION, which is hereby incorporated herein in its entirety by this reference.

### BACKGROUND OF THE INVENTION

1. Field of the Invention

The present invention relates generally to the leasing of real or personal property. More particularly, the present invention is directed to a system and method for selecting at least one property available for lease and negotiating a lease.

The present invention is based on the premise that beyond the basic criteria for selecting lease property, such as rent, for consideration by Lessees to optimize the lease property selection and lease negotiation process, numerous other factors must be included. For example, in the case of Real Estate, the number of factors to be considered varies directly with the location, the size required, the length of the lease term, the complexity of the use, the sophistication of the Real Estate market targeted for occupancy, the requirements for flexibility, the financial strength of the Lessor, etc. The commercial Real Estate industry's current lease property selection process is manual and makes only minimal use of technology in site selection and no use of technology in supporting the evaluation of financial versus qualitative trade-offs in lease terms and optimizing negotiation positions in the leasing of Real Estate. The system and method of the present invention link tools and processes to improve effectiveness in increasing location options and terms and selecting among those options, and to simultaneously accelerate the lease property selection process.

An example in accordance with the present invention enables aggregating a broader array of specifications for potential lease properties than is typically possible to be assembled or considered under current practice, thereby allowing mass customizing of specific Requests for Proposal (RFPs) to which Client Operators (Lessees) then add situation or transaction specific statements for consideration by potential Lessors in various markets. The more comprehensive information obtained in Lessor responses is then used to qualify and rank candidate properties for lease in real time against an array of selected criteria such as costs, timing, flexibility, execution risk, and other criteria previously not possible to evaluate properly with the industry's current essentially manual property selection practice.

Another example of the present invention enables Client Operators/Lessees to identify options with potentially troubling “red flag” issues (e.g., representations regarding hazardous materials or competing firms in the same building) to be identified early and for those issues to be addressed by subject matter experts while the option remains under consideration thereby preserving for additional consideration what ultimately may prove to be the preferred option assuming the red flag issues are resolved satisfactorily.

Another example of the present invention not previously available enables a simultaneous reverse auction process with various potential Lessors on a broad list of the financial or various qualitative lease terms and conditions at multiple points in the selection process.

2. Description of the Prior Art

Generally, the selection of a property to lease can be a daunting, subjective, and imprecise task. In the past, the primary criteria were simply the rent to be paid, the required lease term, and any Lessor concessions for interior renovations.

Today, for both the Lessor and the Client Operator/Lessee, the acceptability of the rent and other headline terms proposed is often at least partially dependent on the terms and conditions of the lease. In many instances, the non-financial terms and conditions of a lease may be as or more important to a Client Operator/Lessee than the rent. However, with general practice being that many items important to the Client Operator/Lessee are not discussed or fully evaluated prior to the selection of a preferred property, it is common for either or both parties in a lease transaction to ultimately be faced with significant compromises on their expectations regarding the suitability, flexibility, cost, or execution risk for a particular property to be leased. Typically, the negotiating advantage in this misalignment of expectations favors the Lessor, because the Lessee normally is faced with pressing critical dates such as to relocate or to open a new office.

Unfortunately, there has been no source for a non-residential Client Operator or Real Estate broker to draw upon in selecting best practice lease deal points to be requested in a RFP and in turn no efficient way to compare them. Further, even with the abbreviated RFP commonly in use, there is no fast or user-friendly way for a Client Operator to understand in real time the trade-offs in selecting one lease property from among many based on careful analysis of responses by potential Lessors.

Presently, the Client Operator often must prematurely dismiss possible locations because fully evaluating a large number of locations is impractical due to the time required to properly evaluate them and the difficulty of dealing with different response formats used by Lessors. This is particularly true for small to medium sized locations where a Client Operator might shorten the Request For Proposals (RFP) to encourage the maximum number of Lessors to respond. However, as a result of shortening the RFP, the Client Operator's decision-making process in selecting a property to lease typically becomes more subjective and has greater risk in several areas. Consequently, the financial, operating, and qualitative results for the Client Operator typically have not been optimized or transparent to the Client Operator before a location is selected. Nor has there been a way to evaluate any premium needed to obtain more favorable non-financial lease terms. Also, it is typically believed that once a Lessor has been informed that its proposal becomes the preferred proposal for a lease property, a Client Operator's ability to obtain concessions from the Lessor on deal points that have not been agreed upon is lost or, at a minimum, is greatly reduced. With the increased sophistication of Lessors and their counsel, and recently with their lenders, these difficulties for a Client Operator have grown.

Thus, it would be desirable to provide a system and method which overcome the above problems that are encountered by prospective Client Operators/Lessees in the market for a property to lease. It is to this end that the present invention is directed. The various examples of the present invention have many advantages, including:

A) a continuously refreshed industry reference source for best practices in preparation of a RFP for numerous types of non-residential properties to which can be added the Client Operator's/Lessee's individual requirements.

B) an automated system and method to score and compare each option, in real time, the raw score, weighted score, and blended scores on either a dashboard or in other Client Operator requested formats based on, for example:
i) the economics proposed in consideration of a broad spectrum of lease terms and conditions;
ii) the relative value of a broad spectrum of terms and conditions on non-economic lease provisions;
iii) flexibility, such as to purchase, expand or contract, or sublease;
iv) execution risk factors;
v) labor analytics;
vi) environmental sustainability; and
vii) economic incentives that may be available to affect whether or not a potential lease is workable and to facilitate negotiation of a lease for a target candidate lease property;

C) a significant improvement in a Client Operator's/Lessee's negotiating leverage, reduction of risk, and improved outcomes gained from:
i) access to a first of its kind and continuously improving industry reference for deal point statements in the RFP;
ii) greatly improved market knowledge from Lessor responses to the RFP;
iii) a check-the-box format that encourages Lessors to respond by minimizing the work needed for them to respond in particular in the early phases on small and mid-size requirements;
iv) a more competitive environment for Lessors to submit proposals than has been possible previously, including but not limited to reverse auctions on a comprehensive list of individual transaction points; and
v) the ability to compare the financial and qualitative performance of service providers and staff.

D) an early warning on “Red Flag” issues allowing simultaneous consideration of those transaction points that may or may not prove fatal to further consideration of a particular option while the option remains under consideration (e.g., the presence of hazardous materials, presence of certain competitors, etc.).

E) the ability to compare and pay on an objective basis for the results achieved by various service providers.

### SUMMARY OF THE INVENTION

The examples of the system and method in accordance with the present invention comprise many innovations in resolving long standing problems encountered by prospective Client Operators, or prospective Lessees, in connection with leasing properties, making the system and method in accordance with the present invention useful to Client Operators in the market for lease properties. One example below of the present invention provides a property selection and lease negotiation system and method that solve the above problems while incurring minimal time or risk to a prospective Client Operator. Using the property selection and lease negotiation system and method in accordance with the present invention, a prospective Client Operator may be provided at the initiation of the transaction and far sooner than previously possible, a comparison of both the economics and a short list of a Client Operator's physical and other “Must Haves” regarding a lease. Thus, the high-level feasibility of a planned lease of a new location can be determined faster and at minimal cost for the Client Operator and Lessor. This early high-level feasibility test serves to assure the Client Operator and prospective Lessor can proceed on the most basic terms or, if a transaction is not feasible, the system and method allow a Client Operator to make changes, such as to reduce the scope, request supplemental funding, or cancel the transaction. This prevents the Client Operator and Lessors wasting time and resources on projects that have a potentially critical mismatch in funding, physical, or other “Must Have” priorities respecting what the market can offer in meeting a specific requirement. Since no industry norm currently exists for a manual or automated process for an early feasibility test in the commercial Real Estate market, the system and method in accordance with the present invention providing an early feasibility test for a commercial lease requirement is a first for the commercial Real Estate arena.

The property selection and negotiation system and method in accordance with the present invention recognize that transaction points that are not raised or mutually agreed in the RFP or letter of intent prior to the selection of a finalist property are either far more difficult to obtain in subsequent negotiations or, more often, simply cannot be obtained since the leverage in being able to choose another option declines immediately once a letter of intent or equivalent is signed. Accordingly, relevant transaction points are incorporated in the RFP for early consideration.

The property selection and negotiation system and method of the present invention provide a robust, first for the industry, reference of best practice statements to be considered for use as deal points in planned transactions. They provide novice and experienced practitioners an extensive selection of best-practice statements for a Client Operator's use in preparing RFPs for leases. These statements draw on numerous sources including Client Operator suggestions for inclusion, providing an opportunity to “raise the bar” continuously for the industry norm in preparation of RFPs for potential leases from what has been essentially a manual, closely held process to one allowing mass customization of RFP preparation, thereby offering significantly better quality information and increased negotiating leverage. This assures for the first time that a greater number of relevant lease factors ranging from “Must Have” to “Minimal” priority appropriate to the size and scope of the requirement can be included by the Client Operator in the RFP (or be purposely omitted) assuring maximum negotiating leverage and customizing the RFP to meet the particular circumstances with essentially little or no additional work required by the Client Operator. When the time and cost required for Client Operators to address deal points that previously would have not been included in the RFP including the cost of items that are not resolved in the Client Operator's favor but otherwise could have been obtained by the Client Operator had those items been included in the RFP are considered, the financial, operating, risk mitigation, and flexibility benefits to the Client Operator of the property selection and lease negotiation system and method of the present invention are substantial.

The property selection and negotiation system and method in accordance with the present invention enable the prospective Client Operator to value and rank the qualitative lease factors such as terms and conditions of a potential lease (e.g., expansion options, early termination rights, renewal options, amenities, execution risk, etc.) simultaneously and in real time with the financial factors so that potential lease points can be evaluated and compared individually or on a blend of financial and qualitative factors weighted according to a prospective Client Operator's preferences. To simplify a Client Operator's review, the results are preferably shown in a dashboard format with supporting information available in a variety of formats.

An example of the lease selection and negotiation system and method of the present invention additionally enables a simultaneous reverse auction process with various potential Lessors on either or both of the financial or qualitative factors of a lease. In effect, the property selection and negotiation system and method provide a prospective Client Operator the automated ability to understand what premium, if any, is required for improved lease terms and conditions or amenities over lower rental cost options and to be confident that a Client Operator's exposure from not addressing lease deal points is eliminated or at least greatly reduced when compared to current practice. Conversely, the property selection and negotiation system and method provide a prospective Client Operator the qualitative compromises in lease terms and conditions, risk, and other factors, if any, that are associated with lower rental cost alternatives and the ability to attribute relative importance or weights to those compromises.

Considered in more detail, one example in accordance with the present invention provides a system and method for aggregating data regarding potential lease properties, identifying candidate properties for lease, using a spreadsheet based program to expedite and standardize analysis of responses to a RFP to include not just rent, but costs and lease provisions, execution risk, flexibility, and other factors respecting the lease of candidate properties, and negotiating a lease for a target candidate property. Another example of the present invention provides a system and method that aggregates the redacted Lessor responses over many RFPs and benchmarks them to determine “market” on non-economic terms and conditions by various descriptors such as size, market, Client Operator's credit, and planned use. Another example in accordance with the present invention provides such a lease selection and negotiation system and method that are Internet or World Wide Web based.

The principles of the present invention can be applied to real estate leases or other types of leases such as personal property leases. When considered over the life of the lease and extension term, the improvement in the Client Operator's cost, operating flexibility, risk, and exposure, the benefits from the system and method are financially and operationally compelling.

The foregoing and other objects, features, and advantages of the present invention will become more readily apparent from the following detailed description of various examples, which proceeds with reference to the accompanying drawing.

### BRIEF DESCRIPTION OF THE DRAWING

The various examples of the present invention will be described in conjunction with the accompanying figures of the drawing to facilitate an understanding of the present invention. In the drawing:

FIG. 1 is a block diagram of a lease selection and negotiation system in accordance with one example of the present invention.

FIG. 2 is a block diagram showing additional features of a lease selection and negotiation system in accordance with an example of the present invention.

FIG. 3 illustrates the interaction among users of one example of the lease selection and negotiation system in accordance with one example of the present invention.

FIG. 4 is a flow diagram of the operation of an example of the lease selection and negotiation system in accordance with the present invention.

FIG. 5 is a flow chart of another example of the lease selection and negotiation method in accordance with the present invention.

### DETAILED DESCRIPTION OF THE EXAMPLES

By way of example, but not limitation, the lease selection and negotiation system and method in accordance with one example of the present invention will be described in conjunction with leasing real estate, for example, commercial Real Estate. The principles of the present invention also apply to other types of leases, including the lease of personal property, for example, vehicles, equipment, or the like.

The present invention is particularly applicable to a computer-implemented property selection and negotiation system and method, and it is in this context that the various examples of the present invention will be described. The property selection and negotiation system may reside on servers, and be Web-enabled. It will be appreciated, however, that the lease property selection and negotiation system and method in accordance with the various examples of the present invention have greater utility, since they may incorporate other modules or functionality not described herein such as tracking the average rent per square foot for lease in a given Real Estate market as a function of the size of the property.

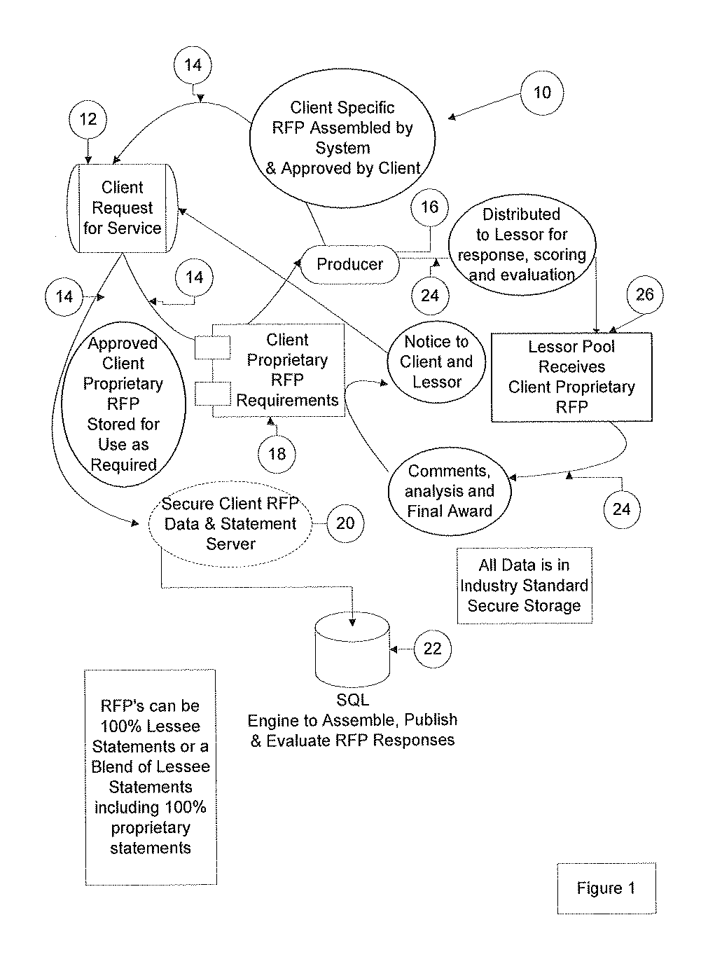

One example of the property selection and negotiation system in accordance with the present invention, generally indicated by the numeral 10 shown in FIG. 1, has the capability and functionality to incorporate RFP requirements and statements for any Client Operator/Lessee for a potential lease. The property selection and negotiation system 10 has the unique capability to create, distribute, and evaluate Lessors' proposals to meet the proprietary lease requirements specified by the particular Client Operator/Lessee. These requirements can be uploaded to the property selection and negotiation system 10 via pathways to a database specifically designed to receive these imported files. These specific requirements can then be associated with the library of RFP templates provided by the property selection and negotiation system 10 for distribution, comment, response, evaluation, and scoring in standard channels flow from a SQL or similar database to the pool of Lessor respondents.

The property selection and negotiation system 10 preferably produces a RFP from statements and requirements of QL in a QL database of similar statements that are entirely provided by the Client Operator/Lessee. Alternatively, the REP can be a blend of statements from either or both the property selection and negotiation system 10 or the Client Operator/Lessee.

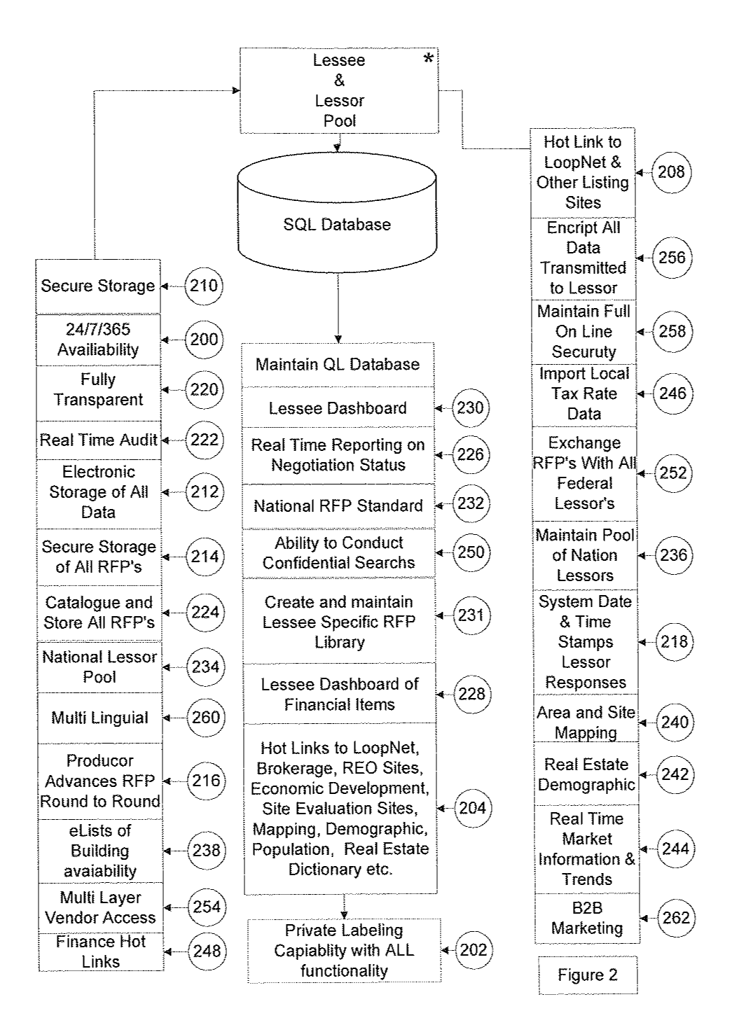

All Client Operator/Lessee proprietary data, requirement statements, financial projections, and any item of information or requirement statement that the Client Operator/Lessee associates with its specific RFP is preferably stored in a secure database. These requirements are preferably maintained in the database and stored to the highest current level of industry standard for storage protocol. All access to the web site illustrated in FIG. 1 is preferably 24/7/365 or other basis. The web site facilitates creation, presentation, usage, storage, distribution, and evaluation of all RFPs and statements. Furthermore, the property selection and negotiation system 10 preferably has the functionality that it can be re-branded for a specific Client Operator/Lessee and viewed as that Client Operator's/Lessee's own web site, as indicated by the numeral 202 shown in FIG. 2.

Considered in more detail, as shown in FIG. 1, a Client Operator/Lessee uses a remote machine 12, such as a personal computer, to access the web site comprising the property selection and negotiation system 10 via a network connection 14, such as an Internet connection. A request for service by the Client Operator/Lessee is received by a producer machine 16, such as a personal computer, comprising the property selection and negotiation system 10. The request for service may be accompanied by proprietary RFP requirements 18 provided by the Client Operator/Lessee, which are received by the producer machine 16. The property selection and negotiation system 10 also comprises a RFP server 20 which produces statements to be potentially incorporated into a RFP using predetermined statements stored in a database 22 and any proprietary requirements provided by the Client Operator/Lessee. The RFP server 20 assembles a RFP, which is transmitted by the producer machine 16 via the network connection 14 to the machine 12 for approval by the Client Operator/Lessee.

The Client Operator/Lessee uses the machine 12 to approve the RFP via the network connection 14. The approval is received by the producer machine 16. The approved RFP is stored by the RFP server 20 in the database 22.

The producer machine 16 then submits a request to the RFP server 20 to access the approved RFP in the database 22 and distributes the approved RFP to potential Lessors via a network connection 24, such as an Internet connection. The approved RFP is received by one or more potential Lessors on one or more machines 26, such as personal computers. The potential Lessors transmit responses to the RFP via the network connection 24, which are received by the producer machine 16. The producer machine 16 preferably supplies the responses from potential Lessors to the RFP server 20 which evaluates and preferably scores the responses. The results of the scoring and/or evaluation of the responses from potential Lessors are accessed by the producer machine 16 and transmitted to the Client Operator/Lessee machine 12 via the network connection 14 for consideration by the Client Operator/Lessee. The Client Operator/Lessee may then decide whether to modify the RFP in view of the responses from the potential Lessors by iterating the above-described process with the objective of eventually entering into a lease of one of the lease properties of responding potential Lessors. In one example implementation, the property selection and negotiation system 100 produces a series of user-friendly MICROSOFT® Excel based (or Web capable) RFPs comprising questionnaires serving as increasingly finer filters.

Additional features of one example of the property selection and negotiation system 10 are illustrated in FIG. 2. The property selection and negotiation system 10 is a combination of a “best in class” suite of tools which are fully web enabled to provide the highest level of lease evaluation, requirement refinement, integrated in-depth financial analysis, risk and detailed market analysis, demographics, and hot links to pertinent market statistics and analytical tools that are fully transparent and available to all users 24/7/365, as indicated by the numeral 200 shown in FIG. 2. The property selection and negotiation system 10 also preferably links to industry resources such as R S Means and the Dodge report for cost benchmarking, as indicated by the numeral 204 shown in FIG. 2. The property selection and negotiation system 10 may link to Costar and other commercial advertising media to identify locations, as indicated by the numerals 206 and 208 shown in FIG. 2, which might have appropriate space for a Client Operator's/Lessee's requirements. Using the property selection and negotiation system 10, RFPs can be tailored by prospective Client Operators/Lessee's for particular needs and are protected such that only selected RFP statements and financial spreadsheet or application software input sheets such as key assumptions in LseMod™ or tenant's financial analysis software are available for response or comments by potential Lessors, as indicated by the numerals 210, 212, and 214 shown in FIG. 2. However, Lessors preferably have the ability to edit the text for any RFP statement, as indicated by the numeral 216 shown in FIG. 2. Lessors editing the RFP text preferably show in a different color such as with MICROSOFT® Word track changes. Lessors editing text also preferably trigger an automatic date and time stamped response of Lessor counteroffers or during the response evaluation period or Client Operator/Lessee counteroffer (as the case may be) until pending agreement on the language for that statement, as indicated by the numeral 218 shown in FIG. 2. The Client Operator/Lessee determines whether and how to include property options with unresolved Lessor counteroffer responses in succeeding RFP rounds, as indicated by the numerals 220, 222, and 224 shown in FIG. 2.

Preferably, individual and collective findings are compared by the property selection and negotiation system 10, as indicated by the numeral 226 shown in FIG. 2. Referring to FIG. 2, results are then preferably reported using a two- or three-dimensional decision matrix, a transformational bid process (e.g., using application software such as lasta or Ariba or proprietary software) or a customized report to: i) generate a traditional or Client Operator/Lessee specific total cost of occupancy financial analysis; ii) qualitative factors only; iii) a blend of qualitative and financial factors; iv) report attributing economic value to expansion, renewal, contractor options, and risk factors; v) a blend of i) and ii) and//or iii) as the client may request, weighted and scored in a variety of forms to include a dashboard, as indicated by the numerals 228 and 230.

The collective responses to RFP statements respecting a target candidate property to be leased are then preferably linked to one of several types of application software (e.g., Intelligent Word, H-lot Does, or PCLS) to automatically prepare a letter of intent to lease, and draft the lease and other documents. Once the final lease document is signed, responses to the RFP statements are used to update the Client Operator's/Lessee's lease database automatically by using software that converts the agreed RFP statements into a format that can be exported into the most popular lease administration systems, as indicated by the numeral 231 shown in FIG. 2. Similarly, the Lessor responses to each agreed RFP statement are preferably included in a redacted database that aggregates responses on various other leases for use in benchmarking, as indicated by the numeral 232 shown in FIG. 2. The property selection and negotiation system 10 also enables the development and maintenance of a national Lessor pool, provides information to Client Operators/Lessees regarding available lease properties, tax rate information, and financing hot links, as indicated by the numerals 234, 236, 238, 240, 242, 244, 246, and 248 shown in FIG. 2. Additionally, as shown in FIG. 2, the property selection and negotiation system 10 enables the Client Operator/Lessee to conduct confidential searches for available lease properties, as well as engage in secure exchanges of RFPs and other data with Lessors, as indicated by the numerals 250, 252, 254, 256, and 258.

Persons skilled in the art will appreciate that other features may be provided and that the systems and techniques described herein are applicable to a wide array of business and personal lease or rental applications. For example, the property selection and negotiation system 10 may support multi-lingual users and enable business-to-business marketing, as indicated by the numerals 260 and 262 shown in FIG. 2

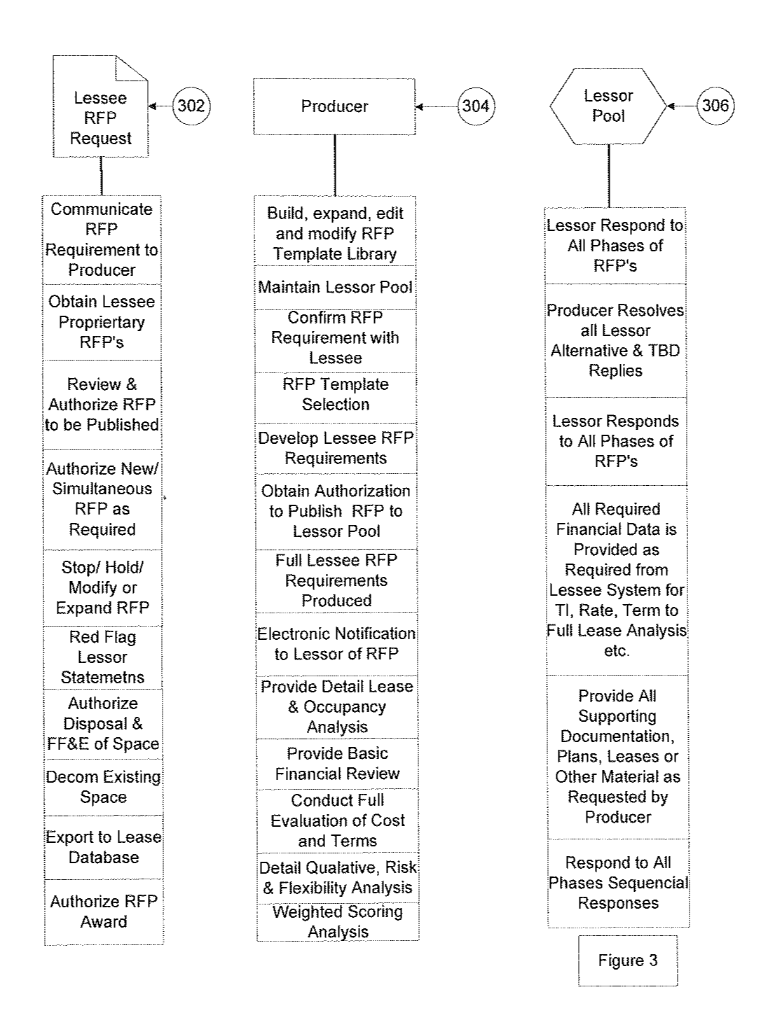

The roles of various users in the operation of the property selection and negotiation system 10 are shown in detail in FIG. 3. These roles are split into three primary areas of user responsibility. The first type of user is the Client Operator/Lessee 302. The second type of user is the “Producer” 304, who is a Broker or, alternatively, an employee or an authorized Client Operator/Lessee representative of the entity which operates the property selection and negotiation system 10. The Producer has full administration rights over the entire platform. The third type of user is one or Lessors 306.

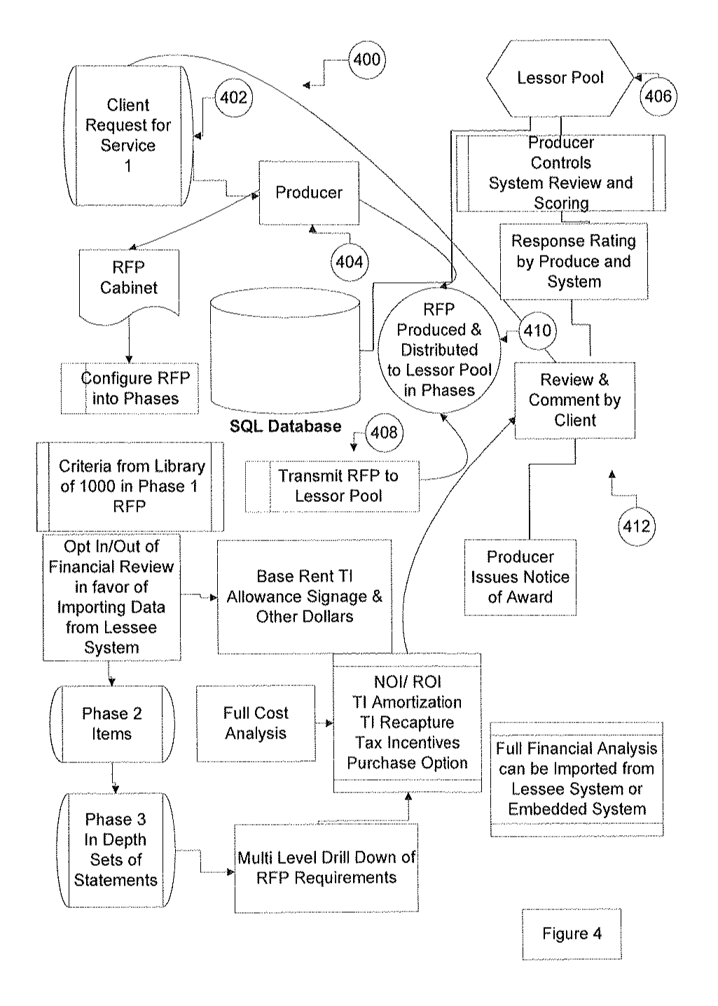

The lease selection and negotiation method in accordance with one example of the present invention comprises a plurality of process steps. The overall RFP generation and response process 400 comprising the lease selection and negotiation method is illustrated in FIG. 4. Generally, the process comprises receiving a request to create a RFP for a Client Operator/Lessee, as indicated by the numeral 402. The Producer, who coordinates, verifies, authorizes, assembles, distributes, evaluates responses, and collects a fee for the service related to RFPs to be generated for a specific assignment, responds to this request, as indicated by the numeral 404. The process also comprises receiving responses to the RFP from one or more Lessors, as indicated by the numeral 406. The lease selection and negotiation method also preferably sets up client specific accounts for any RFP requirements and/or establishes national accounts.

One example of the RFP generation and response process 400 comprising the lease selection and negotiation method shown in FIG. 4 is a process implemented by instructions stored on or in a computer-readable storage medium executed by one or more processors comprising a computer system, for example, the lease selection and negotiation system 10 shown in FIG. 1, to automatically link key traditional and leading edge approaches to lease property selection, financial analysis, construction and operating expense, lease preparation, and the populating of lease databases.

In terms of aggregating potential properties available for lease, this is preferably enhanced by direct email or phone contact by the Producer to Lessors offering appropriate types of properties for lease in a market area and by a property record or database of property records accomplished by subscription to Costar State and local economic development agencies or similar services and entering the property data by keyboard or cut and paste. Alternatively, this data may be imported from a current existing database of available lease properties provided by local Real Estate Brokers. Preferably, the property and Lessor record or database is configured in a way that enables the property record or database to be updated. Also, the property and Lessor record or database is preferably accessible online, which allows data to be updated or the property and Lessor record or database to be populated remotely and Lessors to be notified when new requirements in their markets arise.

The RFP generation and response process 400 comprising the lease selection and negotiation method preferably enables a prospective Client Operator/Lessee to rank/value substantially the full continuum of qualitative or non-financial lease factors (e.g., expansion options, early termination rights, renewal options, amenities, etc.) simultaneously with the financial factors (e.g., rent, etc.) so that potential lease properties can be evaluated and compared on a blend of financial and qualitative factors weighted along with costs according to the prospective Client Operator's/Lessee's preferences, as indicated by the numeral 408 shown in FIG. 4, The RFP generation and response process 400 comprising the lease selection and negotiation method additionally enables a simultaneous reverse auction process with various Lessors on either or both of the financial or qualitative factors. In effect, RFP generation and response process 400 comprising the lease selection and negotiation method provides a Client Operator/Lessee with the automated ability to understand what premium, if any, must be paid for improved lease terms or conditions over lower cost rental options; or, conversely, what qualitative compromises in lease terms and conditions, if any, would be associated with lower cost rentals and attribute relative weights to those compromises.

Considered in more detail, the prospective Client Operator/Lessee self performs or works with his or her Real Estate Broker to select which lease terms and conditions from their own criteria or from the catalog of RFP statements are to be included in the RFP. The Client Operator/Lessee preferably gives each statement and condition a priority, for example, “Must Have,” “Essential,” “High,” “Medium,” “Low,” “Minimal,” or “Not Applicable.” Each priority preferably has a range of scores associated with each possible response. The range allows for variance in the degree of compliance with the particular statement. The Client Operator/Lessee determines the preferred number of RFP bid rounds and which priority statements are to be included in which RFP bid round. Preferably, the lease terms and conditions are grouped by category, for example, Sublease, Holdover, Parking, Waiver of Subrogation, etc.

The RFP generation and response process 400 comprising the lease selection and negotiation method transmits an initial RFP which is preferably sent or made available on a web site to all potential Lessors with the prospective Client Operator's/Lessee's “Must Have” requirements (e.g., space requirements, term of lease, occupancy date, etc., and basic financial terms to be requested), as indicated by the numeral 410 shown in FIG. 4. In another example, the RFP process may be generated at a portal accessible via the World Wide Web that a potential Lessor responds to (i.e., checks off) individual RFP statements with either “Agreed as requested,” “Lessor Counter,” or “Not Granted.”

When the responses to the RFP with the “Must Have” statements are received back by the prospective Client Operator/Lessee and/or his or her Real Estate Broker, the RFP responses are preferably sorted by the RFP generation and response process 400 comprising the lease selection and negotiation method based on raw scores into “Acceptable” and “Unacceptable” lists. Preferably, the RFP generation and response process 400 comprising the lease selection and negotiation method performs a preliminary financial analysis of the acceptable responses based on Generally Accepted Accounting Principles (GAAP) and/or Cash Flow, or the Client Operator's/Lessee's financial evaluation system using other application software, for example, LseMod™. The financial results are compared with the Client Operator's/Lessee's expectations and budget, and the project's feasibility is confirmed or not. The results from the initial RFP round are reviewed by the Client Operator/Lessee for errors, omissions, and items needing clarification, such as in a Client Operator's/Lessee's response to a Lessor counteroffer. The Client Operator/Lessee addresses any need for changes individually or collectively as may be required. After a bid round is completed, the Client Operator/Lessee may also give guidance to Lessors as to their relative standing qualitatively, financially, or both.

After review of the responses to the initial RFP and confirmation by the prospective Client Operator/Lessee and/or his or her Real Estate Broker that a transaction is financially and physically feasible, additional RFPs with more granular terms and conditions which the prospective Client Operator/Lessee desires are preferably made available to qualifying potential Lessors comprising a list of qualified Lessors. The process for the second and succeeding RFP bid round enables Lessors the opportunity to respond in a similar manner as they responded to the initial RFP but with lower priority statements. The procedure for preparing and handling succeeding RFPs, each with more granular, lower priorities, is the same as with the initial RFP, with the Client Operator/Lessee deciding after each round which Lessors will be invited to continue and what guidance, if any, to give to the Lessors. This process, described more fully below, continues with further reductions in the list of qualified Lessors being made until a target candidate property is selected to lease.

As the RFP process continues, candidate properties can be ranked as the Client Operator/Lessee wishes based on pure costs or ranked using a value that the Client Operator/Lessee assigns to lease terms and conditions, execution risk factors or weighted combinations of them, and costs. Resulting scores that are raw, blended, weighted, or transformational and are preferably reported using a generated spread sheet, graph, chart, traditional two- or three-dimensional decision matrix, a green, yellow, or red dashboard, or other customized reports.

Once a decision is made by the Client Operator/Lessee respecting a property to lease, the RFP can preferably be electronically converted into a letter of intent using one of several types of existing commercially available application software. After a lease is executed, the relevant lease terms and conditions can be electronically uploaded to the Client Operator's/Lessee's and Lessor's respective lease administration programs.

The property selection and negotiation method in accordance with the examples of the present invention reduces transaction cycle time and legal fees, increases transparency for the Client Operator/Lessee on a broader array of transaction points than possible using previous methods and tools, increases a prospective Client Operator's/Lessee's negotiating leverage, improves alignment of the non-financial lease provisions with the Client Operator's/Lessee's required and desired features, and potentially reduces occupancy expense. These combine to structure in real time a means for a Client Operator/Lessee to make a rational determination as to whether proposed non-financial terms and conditions bring sufficient added value to justify a premium over lower cost options. Finally, by having the system and method of the present invention provide a consistent scoring method, the Client Operator/Lessee will be able to assess the performance of employees and vendors against internal and external benchmarks.

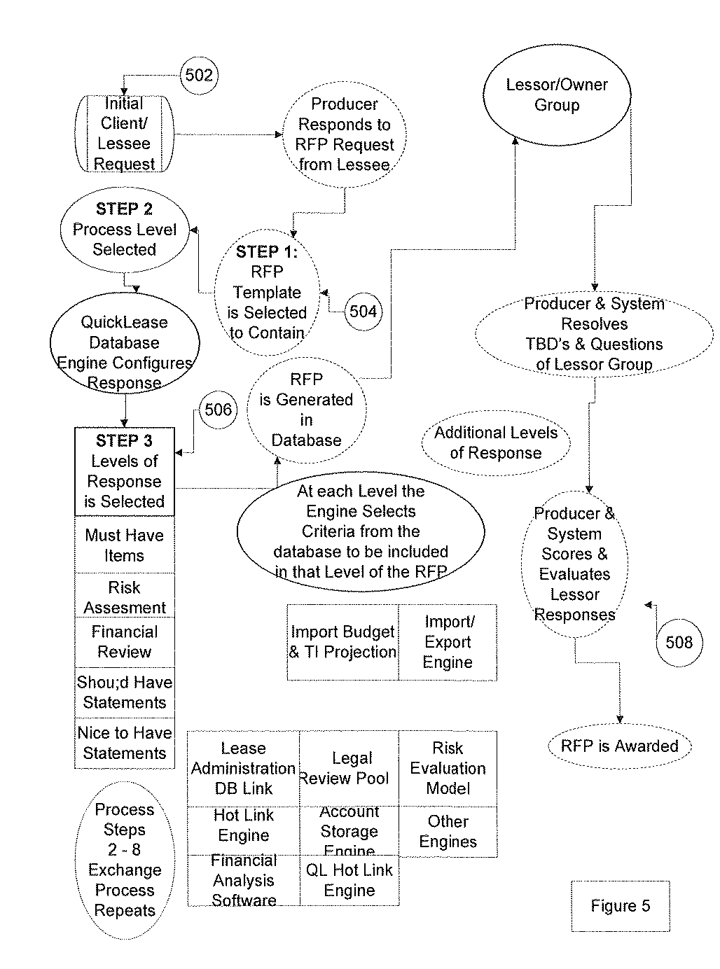

Additionally, appropriately redacted information gathered from the RFP is preferably saved to a database. This database provides an industry resource for high-level or granular benchmarks for transaction costs and lease provisions. The information provides metrics by various identifiers such as transaction date, property age, size, building class, market, or zip code and serves as a current reference as to what market terms or lease language concessions are being granted for various classes and sizes of buildings, for Client Operator/Lessee credit ratings, and other metrics. Individual firms and the broader industry may benefit from benchmarking their results against such an unbiased, comprehensive database of current industry practices. The property selection and negotiation method in accordance with the examples of the present invention significantly improves the quality of decision making in commercial lease property selection, for example. Advantageously, the lease selection and negotiation method can also be adapted for use in selection of property to be purchased or build-to-suit property. The lease selection and negotiation method in accordance with one example of the present invention preferably comprises a spreadsheet application, preferably on a web site, for assembling Lessor responses to RFP statements with the associated priority in concert with graphs and dashboards to show interim and final results. FIG. 5 illustrates one example of an implementation of the lease selection and negotiation method in accordance with the present invention, comprising the following steps:
1. Client Operator representative (or Tenant Rep Broker) and service providers as needed interview Client Operator to confirm “Voice of the Customer” expectations for a new location or a renegotiated lease renewal. A partial list of interview topics includes: the preliminary scope of the requirement including use(s), plan for the property, approximate size, the general physical and service requirements such as electrical, HVAC, parking, janitorial, the preferred schedule for lease execution, possession for interior construction and occupancy, estimated costs to exit and restore the existing location(s), and the availability of operating and capital funds. These expectations form the basis of a request for service, as indicated by the numeral 502 shown in FIG. 5. The request for service also serves as a basis for extracting the statements from the RFP library that apply to the Client Operator's/Lessee's requirements. The variable information, together with Client Operator/Lessee specific requirements are provided by the Client Operator/Lessee on a Needs and Assumptions form that is linked by the system selection and negotiation method in accordance with the present invention to the reference library of RFP statements. A customized RFP statement is then populated automatically by concatenation.
2. The deliverables from the interview are added to the RFP, as indicated by the numeral 504 shown in FIG. 5, and typically include:
   a. Shortlist of the Client Operator's/Lessee's “Must Have” physical, legal, location, availability, term, cost, and other “Must Haves,” including the Client Operator's/Lessee's budget.
   b. A draft RFP with statements organized by category and type of use with the Client Operator/Lessee having the ability to i) insert unique client or transaction specific statements as may be appropriate; ii) select the relative priority for each statement ranging from “Must Have” to “Not Applicable” as appropriate; and iii) a determination as to which statements apply to new Lessors only, existing Lessors only or all Lessors.
   c. Qualitative scores for each RFP statement's priority in the property selection and negotiation method in accordance with the present invention (e.g., “Must Have”, “Essential,” “Medium,” “Low”, Minimal,” or “Not Applicable”)
   d. Client Operator's/Lessee's determination of scores and weighting for qualitative factors from above and key legal, employee, amenity, flexibility, execution risk, environmental, red flag, and location factors as defined by the Client Operator/Lessee.
   e. A determination by the Client Operator/Lessee of how the financial analysis is to be presented, e.g., GAAP based, cash flow, or other financial models requested by the Client Operator/Lessee and/or expanded to include options or feature pricing.
   f. Scores for each response and relative weights for key factors identified by the Client Operator/Lessee such as but not limited to: financial, schedule, employee impact, legal, and location.
3. Client Operator representative (or Tenant Rep Broker) and service providers as needed discuss and obtain agreement with Client Operator/Lessee for the critical path items and occupancy schedule and set an automated red-flag notice process if expectations are not met or are at risk on any key “Voice of the Customer” item. The Client Operator representative (or Tenant Rep Broker):
   a. Through review of Costar and/or other on-line databases of available lease property and their own files and notice to local Real Estate Brokers, identifies locations that appear to meet “Must Have” criteria from above;
   b. Through traditional processes or postings on the web site, identifies key agents or Lessors and locations that appear to meet “Must Have” criteria and provides by phone or email the identity and/or description of Client Operator/Lessee and relevant information such as but not limited to: credit rating, size, type of requirement, planned uses, and timing for control of space for renovations;
   c. Notice that the property selection and negotiation method in accordance with the present invention will be used and invites agents or Lessor by email to review the general information on the Client Operator/Lessee and the requirement described above and information about the system and method in accordance with the present invention starting with reviewing on a no-fee, read-only basis and an invitation to respond to the Client Operator's/Lessee's “Must Have” requirements on the web site, as indicated by the numeral 506 shown in FIG. 5. At the web site, Lessors also learn that the property selection and negotiation method in accordance with the present invention will be used and is:
      i. A largely automated, fully transparent process based on a combination of financial, legal, location, and transaction specific considerations weighted by the potential Client Operator/Lessee.
      ii. An interactive, sequential, and progressively more detailed process building to a short list of properties and final property selection.
      iii. Designed to require initial and subsequent responses from all Lessors by certain specified dates and times.
      iv. Designed to receive and retain Lessor responses and Client Operator/Lessee comments and keep all data confidential and secure in a robust system that date and time stamps and tracks all activity, including “read only” inquiries that provides for saving data and for Client Operators/Lessees and selected evaluators the ability to return to the screen for a transaction at last update by any party.
      v. Designed to acknowledge Lessor responses immediately after a response deadline, evaluates them simultaneously after a response deadline, and after review by the Client Operator/Lessee and selected evaluators identifies short-listed locations by a specific date.
      vi. Designed so that all lease properties to be evaluated will be scored against a list of qualitative and financial criteria established by the Client Operator/Lessee.
      vii. Designed to allow Lessor Counter and Red Flag responses to be addressed off line and in parallel with the Client Operator/Lessee able to determine if and when the evaluations should stop and the lease property dropped from further consideration.
      viii. Designed to export the initial and subsequent financial input to LseMod™, or the Client Operator's/Lessee's financial modeling system or similar key financial assumption sheet or the web address for the specific requirement.
      ix. Designed to provide critical path dates for key selection/lease execution milestones such as response by agent or Lessor, evaluations against macro and comprehensive location selection elements and award of the right to finalize a lease in a letter of intent signed by the Client Operator/Lessee.
      x. Designed to import the initial and subsequent financial output from LseMod™, or the Client Operator's/Lessee's financial modeling system or similar key financial assumption sheet for comparison across all options and with Client Operator's/Lessee's budget and expectations,
      xi. Designed to upload the financial and qualitative results for processing and scoring and reporting.
      xii. Designed to provide phone number and email address contact information and available times to request assistance from Client Operator's/Lessee's representative or Client Operator/Lessee.
      xiii. Designed to request a response to the abbreviated RFP of the Client Operator's/Lessee's physical, legal, financial, and other “Must Haves.”
5. After reviewing the above and the Client Operator's/Lessee's “Must Have” priority statements and typically the financial requirements, Lessors will then receive instructions for submitting secure proposals using the property selection and negotiation process, Lessors will be given a secure identity and password for use on individual transactions. Appropriate measures will be in place to assure Lessors' responses are secure and visible only to authorized parties and at appropriate times. (Note: Lessors typically will not be charged a fee to submit responses in the initial “Must Have” round of statements but to discourage less than sincere proposals Lessors may be charged a minimal fee to respond in later rounds.)
6. After the response date and time for Lessor responses has passed, the property selection and negotiation method in accordance with the present invention then analyzes the Lessors' responses against the Client Operator's requirements and against each other, as indicated by the numeral 508 shown in FIG. 5. For those transactions with Lessors' collective responses indicating that the Client Operator's/Lessee's minimum physical and cost requirements can be met in at least one location, the transaction typically will proceed. If, after reviewing Lessor responses to the minimum requirements described above there is not at least one viable option, the Client Operator/Lessee will typically either:
   a) Redefine the Client Operator's/Lessee's requirements and/or supplement the budget and repeat the above.
   b) Give specific financial and/or schedule requirements for the short list of locations and repeat from #4 above (which can be done in concert with item 6a) above.
   c) Proceed despite the unfavorable variance with the expectation that value engineering or supplemental approval is verbally received to be documented immediately.
   c) Adjust (slip) time lines to meet the projected schedule; or
   e) Defer or cancel the project; or
   f) Other

For operationally and financially viable transactions Client Operators/Lessees then will review the Lessor responses in detail and, where appropriate contact Lessors for clarification on Lessor Counter and Red Flag responses and where appropriate revise or resolve the Lessor Counter responses and then rerun the revised scoring and select and notify the Lessors to be invited to participate in the next round of bids. Lessors not receiving further consideration will also be notified. The invitation will request that Lessors post to the web site by a certain date a) CADD drawings of the space to be leased, b) photos of the interior and exterior of the premises, and c) their position on reimbursing the Client Operator for the commercially reasonable cost of “test fits.”
7. The Client Operator/Lessee (or Tenant rep broker representative) with appropriate external consultants, then conducts:
   a. Location visits and other research (e.g., demographic) to confirm that all selected locations meet all physical, term, location, availability, and other “Must Have” requirements.
   b. For lease properties with satisfactory site tours, request test fits to confirm size requirements, sample layouts, approximate construction schedule, preliminary construction costs, and capital requirements.
8. The Client Operator's/Lessee's representative next compares the results from the above against the Client Operator's/Lessee's criteria and evaluates and adjusts the Lessor responses received for particular locations and reruns the scoring by the present system and method including refreshing construction related cost estimates and revises the list of lease properties to be considered further as appropriate. In turn the lease property selection method in accordance with the present invention is then run again with the Lessors remaining in consideration with increasingly more detailed statements and financial information. The findings from each iteration of statements and responses are then used to aid the Client Operator/Lessee to revise the list of lease properties being considered further.
9. Once one or more viable lease properties have been identified the Client Operator/Lessee or representative:
   a. Invites Lessors with lease properties being considered further to respond in one or several iterations to the expanded RFP or complete RFP list of statements on the Client Operator's/Lessee's RFP including statements such as:
      i. Will the Lessor(s) take the property(ies) off the market for TBD days after the parties sign a letter of intent?
      ii. Have there been any material changes in the building since the RFP process began such as additional space being leased, space becoming available, the building going under contract for sale, or there being a change in management.
   b. Offers Lessors an opportunity for them to revise their financial proposal to improve their ranking.
   c. Offers Lessors an opportunity to revise their proposed lease terms to more closely match terms from competitors and improve their ranking by changing a previous response to “Agreed as requested” or a “Landlord Counter” closer to the Client Operator's/Lessee's requirements.
   d. Sets a date for the Lessor(s) to respond and a schedule for the Client Operator's/Lessee's decision.
10. The Client Operator/Lessee or representative uses input from the above to provide the Client Operator/Lessee an automated ranking of the viable lease properties as generated by the lease selection and negotiation method in accordance with the present invention and evaluates and suggests negotiating opportunities such as to create a reverse auction environment to address a “Lessor Counter” response and improve qualitative terms and scores on each lease property qualifying for further consideration.
11. After Lessors have responded to the last iteration of RFP statements and open items have been resolved with short-listed, viable Lessors, the Client Operator/Lessee reviews the rankings in one or more comparisons as the Client Operator/Lessee may request and either negotiates selected areas where improvement in cost or terms appear possible or may be needed, then upon completion, selects the finalist, signs a letter of intent, or if for some reason the project cannot proceed:
   a. Redefines the Client Operator's/Lessee's requirements and/or supplements the budget and repeats from above as appropriate.
   b. Gives specific financial, schedule, and/or legal targets for the short list of lease properties and repeats from above as appropriate.
   c. Invites short list Lessors to improve legal or financial terms.
   d. Defers or cancels the project.
   e. Other
12. Once a letter of intent is signed, a draft lease is prepared either automatically using available software from others or in the traditional manner.
13. Once a lease is executed, the relevant lease terms can be electronically uploaded to the Client Operator's/Lessee's and Lessor's lease administration programs.
14. A record of the completed transaction, i.e., the reports, can be saved in the Client Operator's/Lessee's or representative's file(s) and redacted and exported into the database of the lease selection and negotiation system in accordance with the present invention for benchmarking and market statistics.

In accordance with one example of the lease selection and negotiation system in accordance with the present invention, the software or code may additionally comprise other software applications such as word processing application software. One example of a word processor that can be utilized in the various examples of the lease selection and negotiation method in accordance with the present invention is MICROSOFT® Word, which is commercially available from Microsoft Corporation.

The lease selection and negotiation system and method in accordance with the present invention benefit Client Operators/Lessees primarily by significantly improving the ability to make an informed, timely, and cost-effective lease property selection decision and increasing and maintaining negotiating leverage for the Client Operator/Lessee. These benefits are achieved by I) assuring that consistent, appropriate, and comprehensive RFPs are prepared irrespective of the service provider, size or type of the requirement, the market, or country, 2) maximizing the number of Lessor responses to the RFPs, 3) early in the process, validating a project's physical, financial, and timing viability and automatically surfacing conceptual gaps, “red flag,” or governance issues, 4) increasing the Client Operator's/Lessee's negotiating leverage and facilitating non-traditional negotiating approaches such as reverse auctions and transformational bid processes, which can include validating the cost versus benefits of particular lease provisions, 5) improving the quality of information available to Client Operators/Lessees versus “Voice of the Customer” expectations prior to the lease property selection decision, 6) allowing closer alignment of the Client Operator/Lessee's representative's compensation to the overall result scored against comprehensive “Voice of the Customer” criteria and target scores, 7) providing Client Operators/Lessees early Red Flag notices on an array of items that may have significant adverse impact and possibly require attention from Client Operator's/Lessee's counsel and others than the RFP evaluators, and 8) facilitating and accelerating the exchange of qualitative and quantitative market data in user-friendly format.

Furthermore, the lease selection and negotiation system and method in accordance with the present invention benefit Lessors mainly by: 1) simplifying the process to respond to initial and follow-up RFPs, reducing the time and cost for Lessors to bid, thereby increasing the number of proposals on which they will choose to bid, 2) limiting the need for detailed responses to those RFPs offering the greatest chance of success and after they have been confirmed as a viable option, 3) providing a higher level of transparency to the decision making process than previously possible, 4) significantly reducing legal fees, 5) reducing transaction cycle time, 6) providing an automatic feed for their lease administration database, and 7) facilitating and accelerating the exchange of qualitative and quantitative market data.

Additionally, the lease selection and negotiation system and method in accordance with the present invention benefit service providers (i.e., Real Estate brokerages) primarily by making it easier to improve the quality of their service and reduce transaction costs and cycle time providing the ability to compare and contrast their performance with competitors and prior practice and provide tools to help a Client Operator/Lessee select a location based on measurable added “soft dollar” value to the Client Operator/Lessee. These benefits are achieved by: 1) providing a user-friendly, robust tool that can accelerate and standardize high quality, comprehensive preparation of RFPs irrespective of the transaction's size, market, or country or an individual Real Estate Broker's skill level, 2) providing a tool to allow early determination of a project's viability, 3) increasing the number of Lessor responses to RFPs, 4) reducing the time and cost required to assemble and analyze data, 5) allowing their Real Estate Brokers to focus on value-added tasks such as improving the effectiveness of the RFPs, closer review of responses, and valuing options and features, 6) providing a teaching tool, and 7) facilitating and accelerating the exchange of qualitative and quantitative market data.

The lease selection and negotiation system and method in accordance with the present invention provide a significant and compelling improvement over the Client Operator's/Lessee's limited focus and leverage seen in present day lease negotiations and lease property selections. By using the lease selection and negotiation system and method in accordance with the present invention, the number of Lessor responses can be maximized, and more thorough information from Lessors can be received long prior to a Client Operator's/Lessee's commitment. Accordingly, the Client Operator's/Lessee's negotiating leverage and outcomes are greatly improved.

By providing automated, early red flags to Client Operators/Lessees, any needed corrections or “deal breakers” are identified in parallel and at the earliest possible point and with the maximum leverage. Lessors failing to resolve the issue satisfactorily can be dismissed earlier than previously attainable. By raising these red flag issues early, particularly at “a favored location” and while the Client Operator's/Lessee's leverage is high and other options remain, the conversion rate to favorable resolution of these issues improves significantly over current experience, or alternatively, another option can be selected with minimal impact on the transaction schedule. This also reduces the likelihood of an insider scripted property solution that cannot be supported by facts.

By enabling the Client Operator/Lessee to more closely align the representative's compensation (e.g., performance based bonus), to the overall result scored against comprehensive “Voice of the Customer” criteria and target scores, it assures the Client Operator's/Lessee's representative's attention is focused on all aspects of the transaction.

The database of redacted statements and responses of the lease selection and negotiation system in accordance with the present invention may serve as an industry resource for Client Operators, Lessors, and the broader industry for high level or granular benchmarks for transaction costs and terms. The information available in the database provides metrics by various identifiers such as age, size, building class, market, or zip code and serves as a current reference as to what “market” terms or lease language concessions are being granted for various classes, sizes of buildings, for Client Operators'/Lessees' credit ratings, size of the requirement, and other metrics. The broader industry will benefit from this unbiased, comprehensive database of historical and current industry practices. Finally, the use of an automated ranking and scoring system and a database of responses by category allow Client Operators/Lessees and their representatives to quantify the cost of multiple tradeoffs among locations and minimize subjectivity in a way not previously attainable and with this knowledge to use methods such as a reverse auction or transformational bid process on individual lease terms.

While the foregoing description has been with reference to particular examples of the present invention, it will be appreciated by those skilled in the art that changes in or additions to these examples may be made without departing from the principles and spirit of the invention. For example, the RFP process may include not just rent, but all costs and all lease provisions for corporate and commercial real estate property selection. Additionally or alternatively, the RFP process may be adapted for purchase or build-to-suit properties worldwide. In another aspect of the present invention, a tutorial on preparation of RFPs, transformational bidding, scoring of statements, use of the database, and valuing non-GAAP items may be provided. This could be used by Client Operators/Lessees and their representatives as an aid in their transactions. The tutorial may have individual chapters for key lease sections describing the financial operating goals and risks for Client Operators/Lessees in each category as an introduction to the then current list of statements for an RFP. The tutorial may also reference and explain how to best use the property selection and negotiation system and database, including, for example, how reference to the database at the outset could help the Client Operator/Lessee or representative in developing the RFP and subsequently in analyzing responses relative to what is typical in the marketplace. Accordingly, the scope of the present invention can only be ascertained with reference to the appended claims.

What is claimed is:

1. A system for leased property selection and lease negotiation, primarily applicable to leased locations, comprising:
a comprehensive and continuously expanding library of statements of Lessee's needs for inclusion in requests for proposal (RFPs);
means for aggregating data regarding potential lease properties;
means for identifying candidate properties for lease;
means for early identification of potential “red flag,”, deal breaker, or high risk issues to allow them to be addressed simultaneously while the property remains in consideration;
means for expediting and standardizing the method for managing a RFP process to include not just rent, but other costs and lease provisions respecting the candidate lease properties;
means for sequencing the RFP into tranches and varying which tranche contains selected RFP statements to adjust the rhythm of the negotiations;
means for clients to self-select the priority and absolute and relative score for individual RFP statements;
means for clients to self-select the components for categories of criteria and the absolute and relative score and weighting for the list of categories being bid upon; and
means for negotiating a lease for a target candidate property.

2. The system of claim 1, further comprising means for enabling a simultaneous reverse auction process with various potential Lessors on either or both the financial or qualitative lease terms and conditions.

3. The system of claim 1, further comprising means for creating a dynamic commercial Real Estate industry standard reference for RFP statements for leases.

4. A method for property selection and lease, comprising the steps of:
aggregating data regarding potential lease properties;
identifying candidate properties for lease;
expediting and standardizing a request for proposal (RFP) process drawing upon an extensive and growing library of RFPs statements and client specific RFP statements to include not just rent, but other costs and lease provisions respecting the candidate lease properties;
creating interim and final reports summarizing the above in raw scores, relative scores, weighted scores, and to allow transformational scoring of the results to
allow a blending of the various elements including one or more of cost, quality, flexibility, execution risk, and labor analytics into a single metric for each option;
negotiating a lease for a target candidate property;
identifying viable Lessors;
ranking the reported results for each Lessor after successive RFP rounds; and
guiding Lessors where their proposals are deficient or incorrect.

5. The method of claim 4, further comprising the step of enabling a simultaneous reverse auction process with various potential Lessors on either or both the financial or qualitative lease terms and conditions.

6. The method of claim 4, further comprising the step of creating a dynamic commercial Real Estate industry standard reference for RFP statements for leases.
